(19) United States
(12) Patent Application Publication
(10) Pub. No.: US 2002/0156983 A1
(43) Pub. Date: Oct. 24, 2002

(54) Method and apparatus for improving reliability of write back cache information

(75) Inventors: Jeffrey Allen Jones, Round Rock, TX (US); Douglas Scott Rothert, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/838,366

(22) Filed: Apr. 19, 2001

(51) Int. Cl. G06F 12/00

(52) U.S. Cl. 711/143; 713/340; 711/113

(57) ABSTRACT

A nonvolatile random access memory is attached to a write back cache. In the case of a power loss, the cache is written to the nonvolatile memory before the machine completely loses power. This may be accomplished by providing a power storage device for use in the event of a power loss. On restart, the contents of the nonvolatile memory are written to the write back cache before any new information may be written. The data may then be written from the cache to the storage device as was intended before the power loss.

### BACKGROUND OF THE INVENTION

1. Technical Field

The present invention relates to data processing systems and, in particular, to computer hard drives. Still more particularly, the present invention provides a method and apparatus for improving the reliability of hard drive cache information.

2. Description of Related Art

Write back cache is a cache that supports the caching of writing. Data normally written to a storage device, such as a hard disk or tape drive, by the central processing unit (CPU) is first written into the cache. When the storage unit is available, i.e. not being written to or read from, the data is written from the cache onto the storage device. Write back caches improve performance, because a write to the high-speed cache is faster than to the storage device.

However, a write back cache adds a degree of risk, because the data stays in memory longer. Cache memories are typically volatile memories. Although it is generally no more than a few seconds until the data is written to the storage device, if the computer crashes or is shut down before data is written, the data is lost.

Therefore, it would be advantageous to improve the reliability of write back cache information.

### SUMMARY OF THE INVENTION

The present invention provides a nonvolatile random access memory attached to a write back cache. In the case of a power loss, the cache is written to the nonvolatile memory before the machine completely loses power. This may be accomplished by providing a power storage device for use in the event of a power loss. On restart, the contents of the nonvolatile memory are written to the write back cache before any new information may be written. The data may then be written from the cache to the storage device as was intended before the power loss.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating a hard disk drive in accordance with a preferred embodiment of the present invention;

FIG. 4 is a diagram illustrating a hard disk controller in accordance with a preferred embodiment of the present invention; and

FIG. 5 is a flowchart illustrating the operation of a cache backup function in accordance with a preferred embodiment of the present invention.

### DETAILED DESCRIPTION OF THE PREFERRED EMBODIMENT

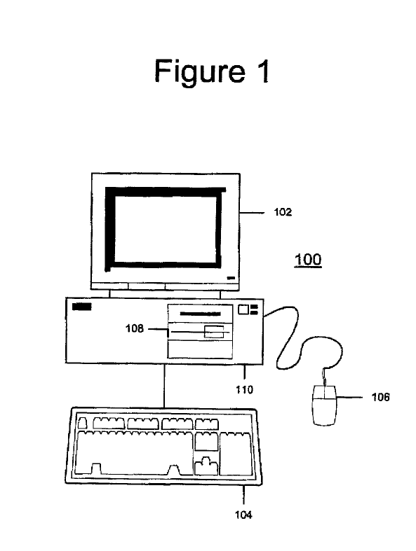

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage device 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

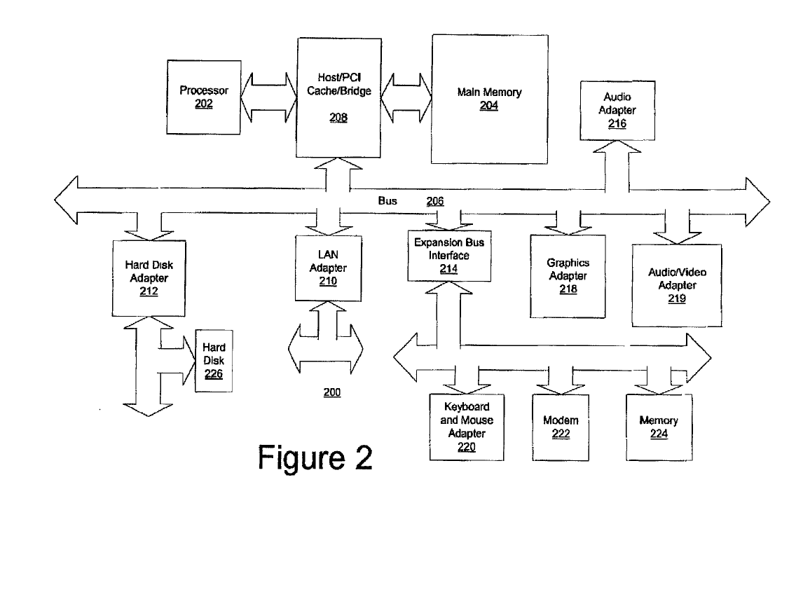

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, hard disk adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. Hard disk adapter 212 provides a connection for hard disk drive 226. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk, telephony device, or a Web appliance.

The processes of the present invention are performed by processor 202 using computer implemented instructions, which may be located in a memory such as, for example, main memory 204, memory 224, or in one or more peripheral devices 226-230.

In accordance with a preferred embodiment of the present invention, a nonvolatile random access memory is attached to a write back cache in hard disk adapter 212. In the case of a power loss, the cache is written to the nonvolatile memory before the machine completely loses power. This may be accomplished by providing a power storage device for use in the event of a power loss. On restart, the contents of the nonvolatile memory are written to the write back cache before any new information may be written. The data may then be written from the cache to the storage device as was intended before the power loss.

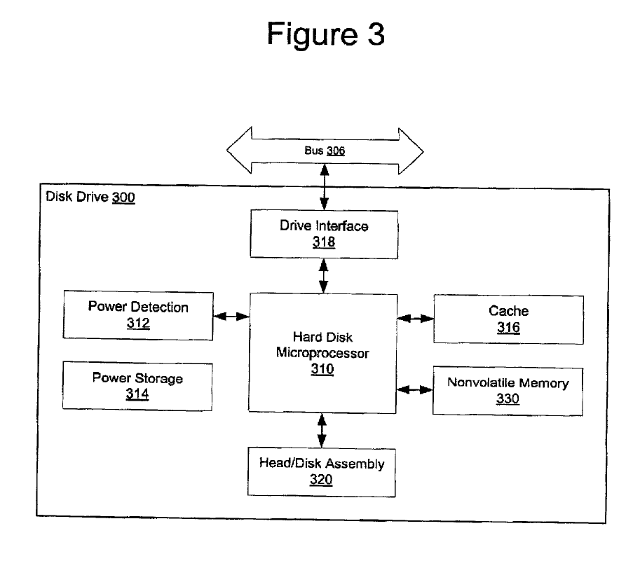

With reference to FIG. 3, a diagram illustrating a hard disk drive is shown in accordance with a preferred embodiment of the present invention. Hard disk drive 300 includes hard disk microprocessor 310. Power detection unit 312 detects when power drops below a threshold, likely indicating power loss due to shutdown of the computer or power failure. Power storage device 314 stores power to be used in case of power loss. For example, power storage device 314 may be a capacitor. Alternatively, the power storage device may be a power source, such as a generator or battery. A small battery, such as a watch battery, may supply sufficient power and may be recharged while power is supplied to the hard drive.

Hard disk microprocessor 310 communicates with bus 306 through drive interface 318. Microprocessor 310 may receive data to write to head/disk assembly 320 from a CPU through drive interface 318. However, the head/disk assembly is an electromechanical device having rotating disks and the microprocessor must seek the cylinder on which to store the data permanently. Thus, data is first written into cache 316, which is significantly faster than head/disk assembly 320. When the head/disk assembly is available, i.e. not being written to or read from, microprocessor 310 may then seek the desired cylinder on the head/disk assembly and store data from the cache. However, numerous write operations may accumulate in the cache and, in the event of a power loss, the contents of the cache memory may be lost before the data is written to the head/disk assembly.

In accordance with a preferred embodiment of the present invention, when power detection unit 312 detects a power loss, hard disk microprocessor 310 writes the contents of cache 316 to nonvolatile memory 330. Nonvolatile memory 330 may be any type of nonvolatile random access memory (RAM) that retains its contents without power, such as flash RAM. Flash RAM is a special type of memory that is used by most handheld computing devices, digital cameras, and digital music players to store operating system, image, music files and other data. The amount of power and time required to write the contents of the cache to nonvolatile memory is significantly less than that required to write the contents to the head/disk assembly. When power is restored, hard disk microprocessor 310 then writes the contents of nonvolatile memory 330 to cache 316 before any new information may be written. The data may then be written from the cache to the head/disk assembly as was intended before the power loss.

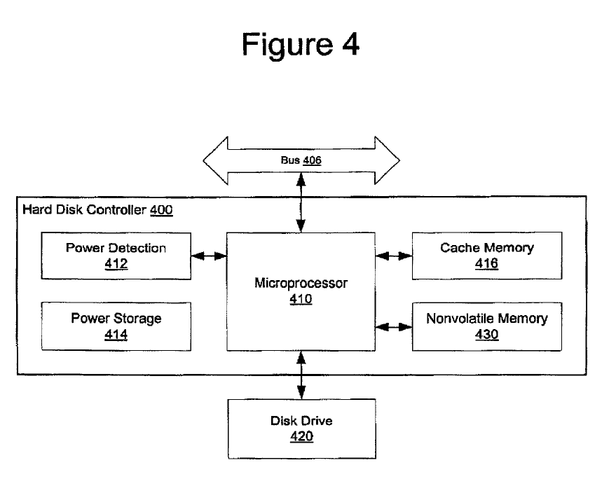

Turning now to FIG. 4, a diagram illustrating a hard disk controller is shown in accordance with a preferred embodiment of the present invention. A hard disk controller is a circuit that controls transmission to and from the disk drive. In a personal computer, a hard disk controller may be an expansion board that plugs into an expansion slot in the bus. Hard disk controller 400 may be an adapter, such as hard disk adapter 212 in FIG. 2.

Hard disk controller 400 includes microprocessor 410. Power detection unit 412 detects when power drops below a threshold, likely indicating power loss due to shutdown of the computer or power failure. Power storage device 414 stores power to be used in case of power loss. For example, power storage device 414 may be a capacitor. The power storage device may also be a power source, such as a generator or battery.

Microprocessor 410 communicates with bus 406. Microprocessor 410 may receive data to write to hard disk drive 420 from a CPU. However, the hard disk is an electromechanical device having rotating disks and the microprocessor must seek the cylinder on which to store the data permanently. Thus, data may be first written into cache 416, which is significantly faster than hard disk 420. During idle machine cycles, microprocessor 410 may then store data from the cache onto the disk drive. However, numerous write operations may accumulate in the cache and, in the event of a power loss, the contents of the cache memory may be lost before the data is written to the hard disk.

In accordance with a preferred embodiment of the present invention, when power detection unit 412 detects a power loss, microprocessor 410 writes the contents of cache 416 to nonvolatile random access memory 430. Nonvolatile memory 430 may be any type of memory that retains its contents without power, such as flash memory. The amount of power and time required to write the contents of the cache to nonvolatile memory is significantly less than that required to write the contents to the hard disk. When power is restored, microprocessor 410 then writes the contents of nonvolatile memory 430 to cache 416 before any new information may be written. The data may then be written from the cache to the hard disk as was intended before the power loss.

While the examples shown in FIGS. 3 and 4 depict a hard disk drive and a hard disk controller, respectively, the storage device may be any storage device for which a cache is implemented. For example, the storage device may be a tape drive, a floppy disk drive, a compressed media drive, or an optical storage device.

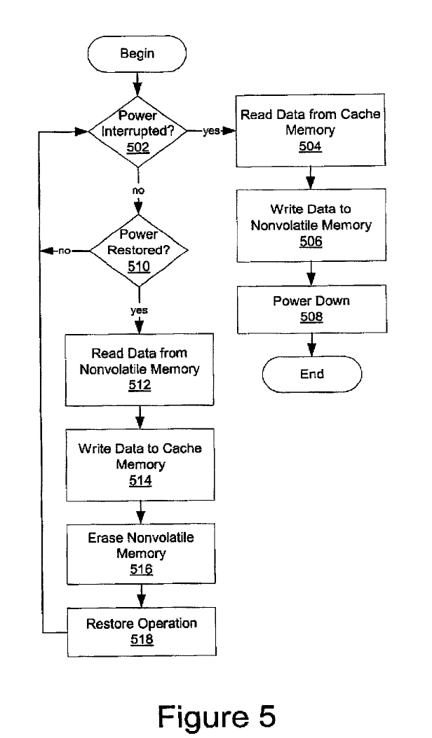

With reference to FIG. 5, a flowchart is shown illustrating the operation of a cache backup function in accordance with a preferred embodiment of the present invention. The process begins and a determination is made as to whether power is interrupted (step 502). If power is interrupted, the process reads data from write back cache memory (step 504) and writes the data to nonvolatile memory (step 506). Next, the storage device or controller powers down (step 508) and the process ends.

If power is not interrupted in step 502, a determination is made as to whether power is restored (step 510). The process may determine whether power is restored by examining the contents of nonvolatile memory. If the nonvolatile memory contains data, the process may assume that power has previously been interrupted and that power has now been restored. Thus, the storage device or controller may suspend operation as long as the nonvolatile memory contains data. If power is restored, the process reads data from nonvolatile memory (step 512), writes the data to cache memory (step 514), and erases the contents of the nonvolatile memory (step 516). Thereafter, the process restores operation of the storage device or controller (step 518) and returns to step 502 to determine whether power is interrupted. If power is not being restored in step 510, the process returns to step 502 to determine whether power is interrupted.

Thus, the present invention solves the disadvantages of the prior art by providing a nonvolatile memory attached to a write back cache. In the case of a power loss, the cache is written to the nonvolatile memory before the machine completely loses power. This may be accomplished by providing a power storage device for use in the event of a power loss. The amount of power and time required to write the contents of the cache to nonvolatile memory is significantly less than that required to write the contents to the storage device. On restart, the contents of the nonvolatile memory are written to the write back cache before any new information may be written. The data may then be written from the cache to the storage device as was intended before the power loss.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system. The processes may then be incorporated into devices, such as storage devices and controller devices, by installing firmware into the devices or by updating flash memory within the devices.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing a write back cache, comprising:
detecting a power interruption; and
in response to detecting a power interruption, writing contents of a cache memory to a nonvolatile random access memory.

2. The method of claim 1, further comprising:
detecting a power restore; and
in response to detecting a power restore, writing contents of a nonvolatile random access memory to a cache memory.

3. The method of claim 2, wherein the step of detecting a power restore comprises detecting whether the nonvolatile random access memory contains data.

4. The method of claim 2, further comprising erasing the contents of the nonvolatile random access memory after the contents have been written to the cache memory.

5. The method of claim 1, wherein the step of detecting a power interruption comprises detecting whether power falls below a predetermined threshold.

6. A method for managing a write back cache, comprising:
detecting a power restore; and
in response to detecting a power restore, writing contents of a nonvolatile random access memory to a cache memory.

7. The method of claim 6, wherein the step of detecting a power restore comprises detecting whether the nonvolatile random access memory contains data.

8. The method of claim 6, further comprising erasing the contents of the nonvolatile random access memory after the contents have been written to the cache memory.

9. An apparatus for managing a write back cache, comprising:
first detection means for detecting a power interruption; and
first writing means for writing contents of a cache memory to a nonvolatile random access memory in response to detecting a power interruption.

10. The apparatus of claim 9, further comprising:
second detection means for detecting a power restore; and
second writing means for writing contents of a nonvolatile random access memory to a cache memory in response to detecting a power restore.

11. The apparatus of claim 9, wherein the first detection means comprises means for detecting whether power falls below a predetermined threshold.

12. An apparatus for managing a write back cache, comprising:
detection means for detecting a power restore; and
writing means for writing contents of a nonvolatile random access memory to a cache memory in response to detecting a power restore.

13. The apparatus of claim 12, wherein the detection means comprises means for detecting whether the nonvolatile random access memory contains data.

14. The apparatus of claim 12, further comprising means for erasing the contents of the nonvolatile random access memory after the contents have been written to the cache memory.

15. A hard disk drive, comprising:
a processor;
a head/disk assembly;
a cache; and
a nonvolatile random access memory,
wherein the processor stores data to be written to the head/disk assembly in the cache and, upon a power interruption, stores contents of the cache to the nonvolatile random access memory.

16. The hard disk drive of claim 15, wherein the nonvolatile random access memory comprises a flash random access memory.

17. The hard disk drive of claim 15, further comprising:
a power storage device, wherein the power storage device supplies power to the processor, cache, and nonvolatile random access memory device when the power is interrupted.

18. A hard disk drive, comprising:
a processor;
a head/disk assembly;
a cache; and
a nonvolatile random access memory,
wherein the processor, upon a restoration of power, stores contents of the nonvolatile random access memory to the cache and writes data from in the cache to the head/disk assembly.

19. The hard disk drive of claim 18, wherein the nonvolatile random access memory comprises a flash random access memory.

20. A data storage device controller, comprising:
a processor;
a cache; and
a nonvolatile random access memory,
wherein the processor stores data to be written to a data storage device in the cache and, upon a power interruption, stores contents of the cache to the nonvolatile random access memory.

21. The data storage device controller of claim 20, wherein the nonvolatile random access memory comprises a flash random access memory.

22. The data storage device controller of claim 20, further comprising:
a power storage device, wherein the power storage device supplies power to the processor, cache, and nonvolatile random access memory device when the power is interrupted.

23. A data storage device controller, comprising:
a processor;
a cache; and
a nonvolatile random access memory,
wherein the processor, upon a restoration of power, stores contents of the nonvolatile random access memory to the cache and writes data from in the cache to a data storage device.

24. The data storage device controller of claim 23, wherein the nonvolatile random access memory comprises a flash random access memory.

25. A computer program product, in a computer readable medium, for managing a write back cache, comprising:
instructions for detecting a power interruption; and
instructions for writing contents of a cache memory to a nonvolatile random access memory in response to detecting a power interruption.

26. The computer program product of claim 25, further comprising:
instructions for detecting a power restore; and
instructions for writing contents of a nonvolatile random access memory to a cache memory in response to detecting a power restore.

27. A computer program product, in a computer readable medium, for managing a write back cache, comprising:
instructions for detecting a power restore; and
instructions for writing contents of a nonvolatile random access memory to a cache memory in response to detecting a power restore.
